(19) United States
(12) Patent Application Publication
(10) Pub. No.: US 2023/0203238 A1
(43) Pub. Date: Jun. 29, 2023

(54) COPOLYMER, RESIN, AND COMPOSITE MATERIAL

(71) Applicant: INDUSTRIAL TECHNOLOGY RESEARCH INSTITUTE, Hsinchu (TW)

(72) Inventors: Wen-Pin TING, Huwei Township (TW); Kuei-Yi CHUANG, Hsinchu City (TW); Yu-Hsiang HSIAO, Ji'an Township (TW); Wei-Ta YANG, Taoyuan City (TW)

(73) Assignee: INDUSTRIAL TECHNOLOGY RESEARCH INSTITUTE, Hsinchu (TW)

(21) Appl. No.: 17/866,043

(22) Filed: Jul. 15, 2022

(30) Foreign Application Priority Data
Dec. 29, 2021 (TW) 110149262

(51) Int. Cl. C08G 59/28; C08G 59/40

(52) U.S. Cl. CPC C08G 59/28; C08G 59/4014

(57) ABSTRACT

A copolymer is formed by reacting a composition I, which includes (a) a first epoxy compound having a chemical structure of

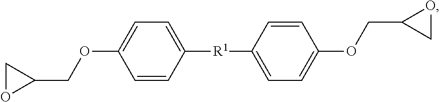

wherein R¹ is single bond, —O—,

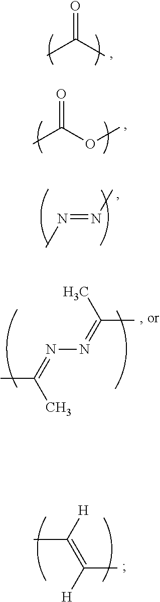

(b) a second epoxy compound that is different from (a) the first epoxy compound, and (c) a curing agent. The copolymer can be mixed with inorganic powder to form a composite material.

### CROSS REFERENCE TO RELATED APPLICATIONS

The present application is based on, and claims priority from, Taiwan Application Serial Number 110149262, filed on Dec. 29, 2021, the disclosure of which is hereby incorporated by reference herein in its entirety.

### TECHNICAL FIELD

The technical field relates to a copolymer and a resin containing the copolymer, and in particular it relates to a monomer of the copolymer.

### BACKGROUND

The 5G mobile communication network was launched in 2020, driving the rise of Bluetooth wireless communication, servers, and the cloud-based internet-of-things (IoT) technology. As the frequency of the electromagnetic band increases, the specification requirements on low-dielectric-loss materials for high frequency become stricter. Because circuit boards and IC substrates for communication products are tending towards high-speed and high-density integration, the PCB substrates not only require a low dielectric constant and low dielectric loss, but also high heat transfer properties.

Accordingly, a novel polymer having high heat transfer property, low coefficient of thermal expansion, low dielectric constant, low dielectric loss (dissipation factor) is called for.

### SUMMARY

One embodiment of the disclosure provides a copolymer, formed by reacting a composition I, wherein the composition I includes: (a) a first epoxy compound having a chemical structure of

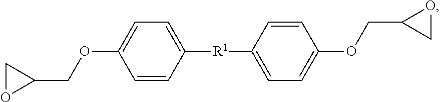

wherein R¹ is single bond,

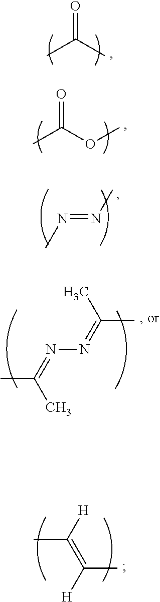

(b) a second epoxy compound that is different from (a) the first epoxy compound; and (c) a curing agent.

One embodiment of the disclosure provides a composite material, including the described copolymer and inorganic powder, wherein the copolymer and the inorganic powder have a weight ratio of 100:30 to 100:300.

One embodiment of the disclosure provides a resin, formed by reacting a composition O, wherein the composition O includes a first copolymer and a second copolymer, wherein the first copolymer is formed by reacting a composition I, and the composition I includes: (a) a first epoxy compound having a chemical structure of

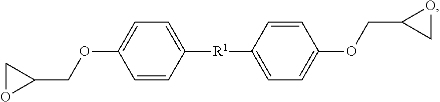

wherein R¹ is single bond,

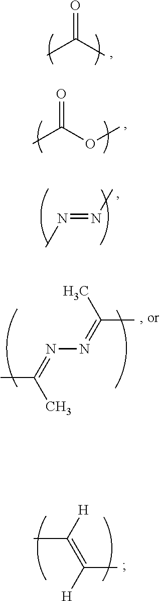

(b) a second epoxy compound that is different from (a) the first epoxy compound; and (c) a curing agent, wherein the second copolymer is formed by reacting a composition II, and the composition II includes: (d) an aromatic monomer, an oligomer thereof, or a polymer thereof; and (e) an aliphatic monomer, an oligomer thereof, or a polymer thereof, wherein the aromatic monomer has a chemical structure of

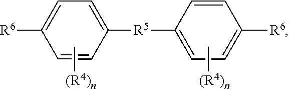

wherein R⁴ is CH₃ and n is 0 to 4; R⁵ is single bond,

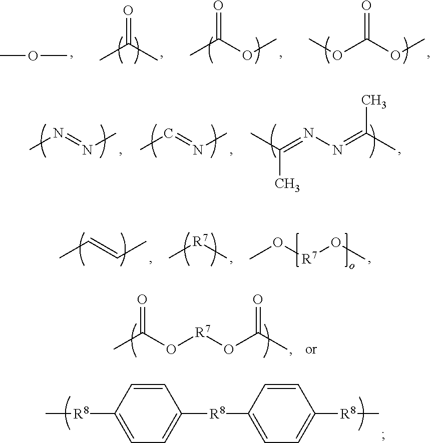

R⁷ is C₂₋₁₀ alkylene group; each of R⁸ is independently single bond,

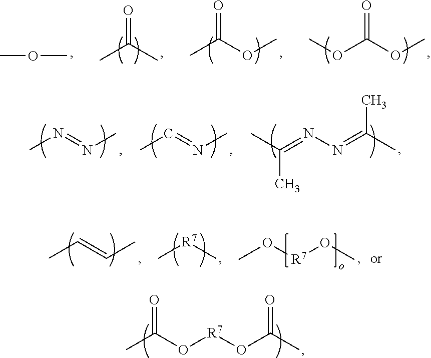

and o is 1 to 70; each of R⁶ is independently

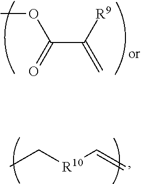

wherein R⁹ is H or CH₃, and R¹⁰ is C₁₋₁₀ alkylene group.

One embodiment of the disclosure provides a composite material, including the described resin and inorganic powder, wherein the resin and the inorganic powder have a weight ratio of 100:30 to 100:300.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a copolymer, formed by reacting a composition I, wherein the composition I includes: (a) a first epoxy compound having a chemical structure of

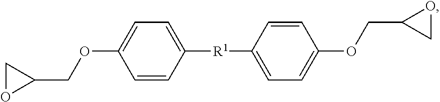

wherein R¹ is single bond,

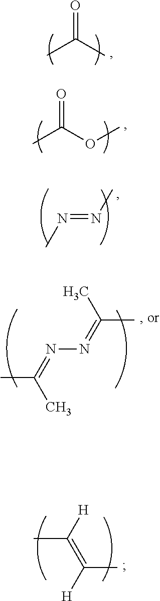

(b) a second epoxy compound that is different from (a) the first epoxy compound; and (c) a curing agent.

In some embodiments, (a) the first epoxy compound includes

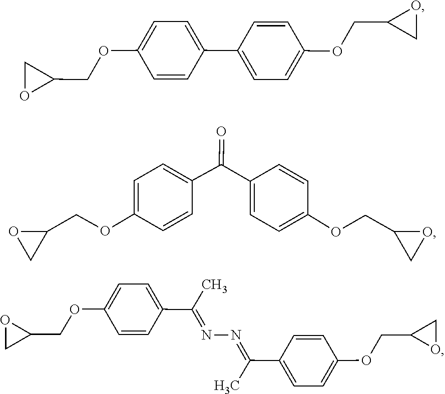 [SMILES: c1cc(-c2ccc(OCC3CO3)cc2)ccc1OCC1CO1 ; O=C(c1ccc(OCC2CO2)cc1)c1ccc(OCC2CO2)cc1 ; C/C(=N\N=C(/C)c1ccc(OCC2CO2)cc1)c1ccc(OCC2CO2)cc1]

or a combination thereof.

In some embodiments, (b) the second epoxy compound has a chemical structure of

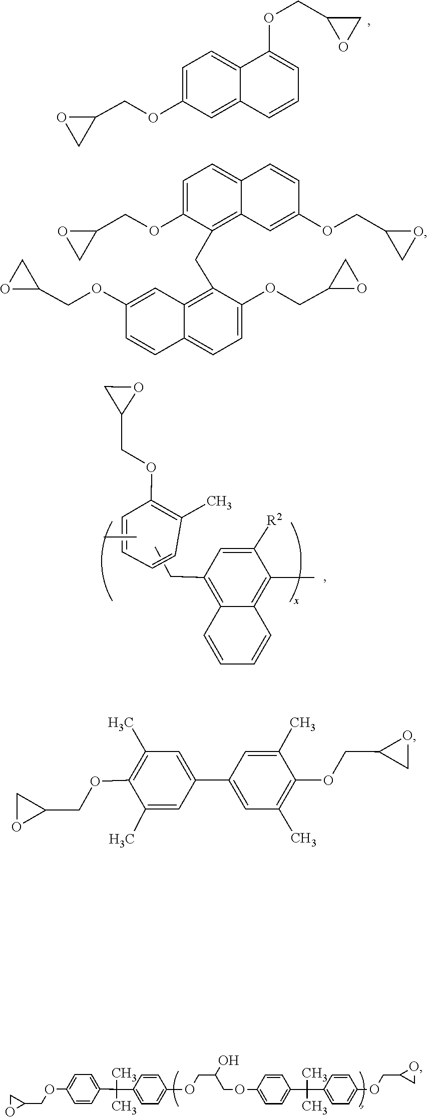

or a combination thereof, wherein R² is CₙH₂ₙ₊₁, n is 1 to 5, x is 1 to 3, and y is 0 to 2.

In some embodiments, (a) the first epoxy compound and (b) the second epoxy compound have an equivalent ratio of 100:1 to 100:120, 100:2 to 100:120, 100:2 to 100:100, or 100:50 to 100:120. The resin with the suitable ratio of (a):(b) tends to achieve a lower coefficient of thermal expansion and remain excellent heat transfer property.

In some embodiments, (c) the curing agent has a chemical structure of

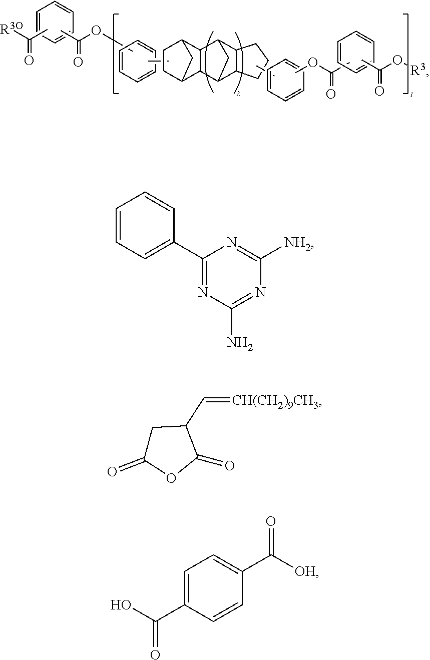

or a combination thereof, wherein each of R³ is independently phenyl or naphthyl, k is 0 to 3, and 1 is 0 to 5.

In some embodiments, the total equivalent of (a) the first epoxy compound and (b) the second epoxy compound and the equivalent of (c) the curing agent have a ratio of 100:70 to 100:120 or 100:90 to 100:100. The resin will be cured more complete with the suitable ratio of (a)+(b):(c). Furthermore, the electrical degradation in the products caused by excessive polar groups (e.g. resulted from chain disconnection by heating) can be reduced.

One embodiment of the disclosure provides a composite material, including the described copolymer and inorganic powder, wherein the copolymer and the inorganic powder have a weight ratio of 100:30 to 100:300. The inorganic powder can be aluminum nitride, boron nitride, alumina (i.e. aluminum oxide), magnesium hydroxide, silica, or a combination thereof. The inorganic powder may further reduce the dielectric constant, dielectric loss, and coefficient of thermal expansion of the copolymer. The inorganic powder of the appropriate ratio is more easily dispersed in the copolymer.

One embodiment of the disclosure provides a resin, formed by reacting a composition O, wherein the composition O includes a first copolymer and a second copolymer. The first copolymer is the described copolymer, which can be formed by reacting the composition I, and the detailed description is not repeated here. The second copolymer is formed by reacting a composition II, and the composition II includes: (d) an aromatic monomer, an oligomer thereof, or a polymer thereof; and (e) an aliphatic monomer, an oligomer thereof, or a polymer thereof, wherein the aromatic monomer has a chemical structure of

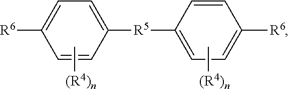

wherein R⁴ is CH₃ and n is 0 to 4; R⁵ is single bond,

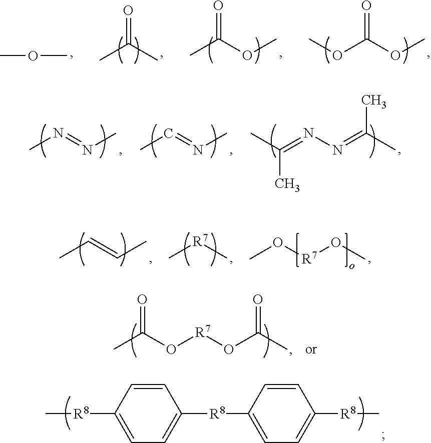

R⁷ is C₂₋₁₀ alkylene group; each of R⁸ is independently single bond,

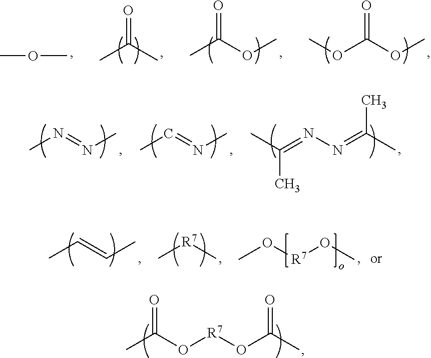

and o is 1 to 70; each of R⁶ is independently

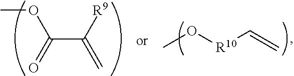

wherein R⁹ is H or CH₃, and R¹⁰ is C₁₋₁₀ alkylene group.

In some embodiments, the aromatic monomer has a chemical structure of

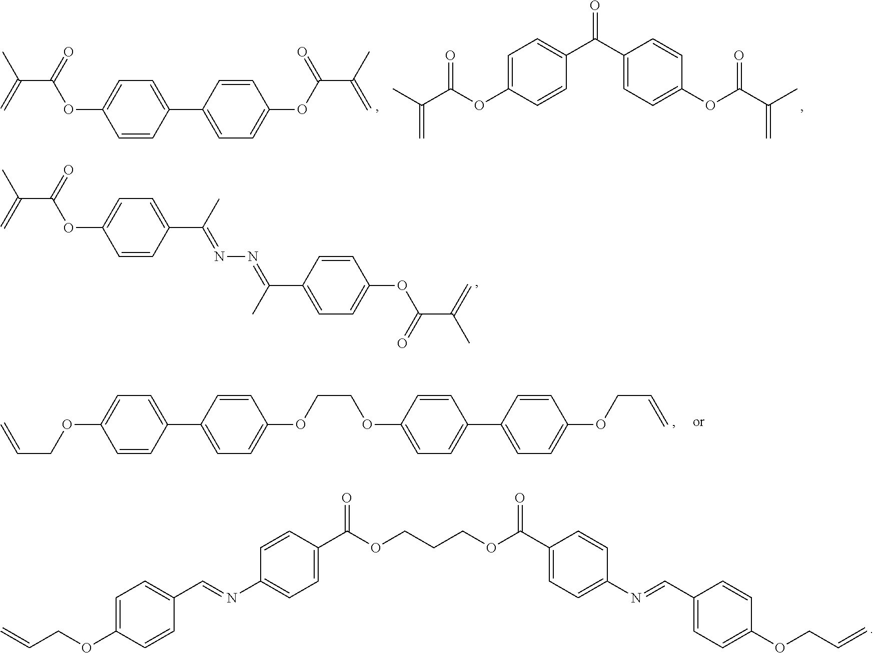

In some embodiments, the aliphatic monomer is 1,3-butadiene, isoprene, 1,3-pentadiene, 2,3-dimethyl-1,3-butadiene, 2-methyl-1,3-pentadiene, 2,3-dimethyl-1,3-pentadiene, 4,5-diethyl-1,3-octadiene,

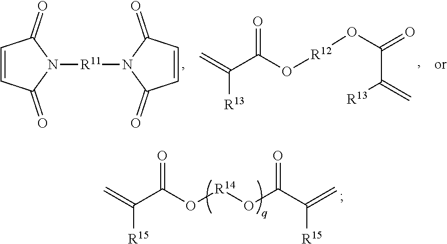

wherein R¹¹ is C₁₋₁₂ alkylene group or cycoalkylene group; R¹² is

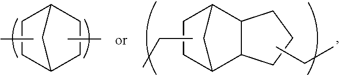

each of R¹³ is independently H or CH₃; R¹⁴ is C₂₋₅ alkylene group; each of R¹⁵ is independently H or CH₃; and q is 1 to 70.

In some embodiments, the aliphatic monomer is 1,3-butadiene,

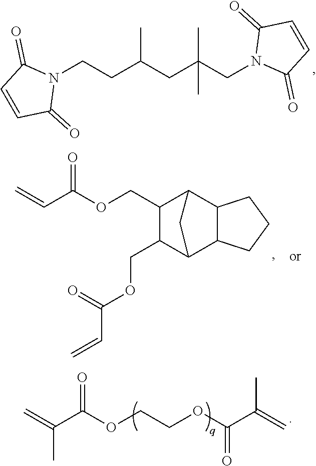

In some embodiments, (d) the aromatic monomer, an oligomer thereof, or a polymer thereof; and (e) the aliphatic monomer, an oligomer thereof, or a polymer thereof have a molar ratio (d/e) of 1:2 to 99:1. If the amount of (d) the aromatic monomer, an oligomer thereof, or a polymer thereof is too low, the second copolymer will have an insufficient heat transfer property, thereby causing the resin have an insufficient heat transfer property.

Furthermore, the enablement and specific detail of the second copolymer may refer to the U.S. patent application Ser. No. 17/497,673 that is filed by the applicant earlier.

In some embodiments, the first copolymer and the second copolymer have a weight ratio of 100:5 to 100:120. If the amount of the second copolymer is too high, the coefficient of the thermal expansion of the resin will be too high.

One embodiment of the disclosure provides a composite material, including the described resin and inorganic powder, wherein the resin and the inorganic powder have a weight ratio of 100:30 to 100:300. The inorganic powder can be aluminum nitride, boron nitride, alumina, magnesium hydroxide, silica, or a combination thereof. The inorganic powder may further reduce the dielectric constant, dielectric loss, and coefficient of thermal expansion of the resin. If the amount of the inorganic powder is too high, the inorganic powder will not be easily dispersed in the resin.

In one embodiment, the copolymer, resin, or the composite can be applied as an adhesive or an encapsulation material. In one embodiment, the coating material (containing organic solvent) of the copolymer, the resin, or the composite material can be coated onto a support, and then baking dried to form a coating layer. In some embodiments, the support can be copper foil, polymer film (e.g. polyimide film, polyethylene terephthalate film, or another polymer film), or the like. The coating layer has high heat transfer property (e.g. heat transfer coefficient (w/mK) ≥0.28, or even ≥0.4), low coefficient of thermal expansion (CTE≤60 ppm/° C., or even ≤50 ppm/° C.), low dielectric constant at high frequency (Dk@10 GHz≤3.2, or even ≤2.8), and low dielectric loss at high frequency (Df@10 GHz≤0.007, or even ≤0.005).

In one embodiment, supports (each includes a coating layer thereon) are laminated, in which the coating layers are in contact with each other. When the supports are copper foils, the laminated structure is the so-called copper clad laminate. In one embodiment, the lamination process is performed under a pressure of 5 Kg to 50 Kg at a temperature of 150° C. to 250° C. for a period of 1 hour to 10 hours.

In one embodiment, a reinforcing material can be impregnated into the coating material (A-stage). The impregnated reinforcing material is placed in an oven at 50.0° C. to 500.0° C., and then baking dried to form a prepreg (B-stage). In one embodiment, the reinforcing material includes glass, ceramic, carbon material, resin, or a combination thereof, and the reinforcing material may have a shape of fiber, powder, sheet, a woven fabric, or a combination thereof. For example, the reinforcing material can be glass cloth. The prepreg has high heat transfer property, low coefficient of thermal expansion, low dielectric constant under high frequency, low dielectric constant loss, and the like. In one embodiment, one or more prepregs can be interposed between copper foils, and then laminated to form a copper clad laminate. In one embodiment, the lamination process is performed under a pressure of 5 Kg to 50 Kg at a temperature of 150° C. to 250° C. for a period of 1 hour to 10 hours.

Below, exemplary embodiments will be described in detail so as to be easily realized by a person having ordinary knowledge in the art. The inventive concept may be embodied in various forms without being limited to the exemplary embodiments set forth herein.

### EXAMPLES

In the following Examples, the heat transfer coefficient (W/mK) of the coating layer was measured according to the standard ASTM-D5470, the coefficient of thermal expansion of the coating layer was measured according to the standard ASTM-2113-04, and the dielectric constant and the dielectric loss of the coating layer were measured according to the standard JIS-C2565.

### Synthesis Example 1

4,4′-Biphenol (186 g, 1 mol), epichlorohydrin (370 g, 2.4 mol), and tetra-n-butylammonium bromide (17 g, 0.2 mol) were mixed and heated to 90° C. under nitrogen and allowed to react for 2 hours. 40% of sodium hydroxide aqueous solution (1L) was then added to the reaction to continuously react for 1.5 hours. The reaction result was poured into 2 L of methanol to precipitate the product, stirred, and then filtered to collect the solid, which was washed with water and then baking dried to obtain the product (283 g). The product had a chemical structure of

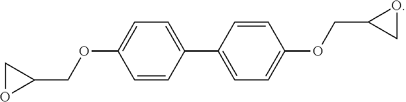 [SMILES: c1cc(-c2ccc(OCC3CO3)cc2)ccc1OCC1CO1]

### Synthesis Example 2

4,4′-Dihydroxybenzophenone (214 g, 1 mol), epichlorohydrin (370 g, 2.4 mol), and tetra-n-butylammonium bromide (17 g, 0.2 mol) were mixed and heated to 90° C. under nitrogen and reacted for 2 hours. 40% of sodium hydroxide aqueous solution (1L) was then added to the reaction to continuously react for 1.5 hours. The reaction result was poured into 2 L of methanol to precipitate the product, stirred, and then filtered to collect the solid, which was washed with water and then baking dried to obtain the product (312 g). The product had a chemical structure of

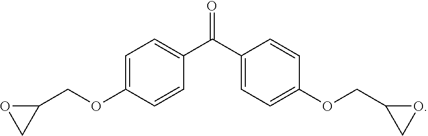 [SMILES: O=C(c1ccc(OCC2CO2)cc1)c1ccc(OCC2CO2)cc1]

### Synthesis Example 3

4-hydroxyacetophenone (136 g, 1 mol), epichlorohydrin (370 g, 2.4 mol), and tetra-n-butylammonium bromide (8.4 g, 0.1 mol) were mixed and heated to 90° C. under nitrogen and reacted for 2 hours. 2M sodium hydroxide aqueous solution (700 mL) was then added to the reaction to stir overnight, and then filtered to collect the solid. The solid was washed with water and then baking dried to obtain an intermediate product (198 g, yield=95%). The intermediate product, hydrazine sulfate (64 g, 0.49 mol), and triethylamine (49 g, 0.49 mol) were added to ethanol (200 g), and heated to reflux and react for 5 hours, and then cooled down to room temperature to precipitate solid. The solid was then washed with ethanol and de-ionized water, and then baking dried to obtain a product (120 g). The product had a chemical structure of

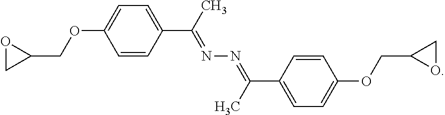 [SMILES: C/C(=N\N=C(/C)c1ccc(OCC2CO2)cc1)c1ccc(OCC2CO2)cc1]

### Example 1

373 g of the product in Synthesis Example 1, 6.8 g of an anthracene type diepoxy compound 4032D commercially available from DIC, 227 g of a curing agent 8000-65T commercially available from DIC, and 3 g of an initiator DMAP (4-(Dimethylamino)pyridine commercially available from Aldrich) were dissolved in 1000 mL of tetrahydrofuran (THF). The THF solution was refluxed and reacted for 2 hours to obtain a copolymer. The product in Synthesis Example 1 (e.g. (a) first epoxy compound) and 4032D (e.g. (b) the second epoxy compound) had a molar ratio of 98:2. (a) The first epoxy compound and (b) the second epoxy compound had an equivalent ratio of 100:2.04. The total equivalent of (a) the first epoxy compound and (b) the second epoxy compound and the equivalent of (c) the curing agent had a ratio of about 100:90. The copolymer was coated to form a film, and then baking dried to form a coating layer with a thickness of about 100 μm. The coating layer had a heat transfer coefficient of 0.428 W/mK, a coefficient of thermal expansion of 43.9 ppm/° C., and a glass transition temperature (Tg) of 179° C. 4032D had a chemical structure of

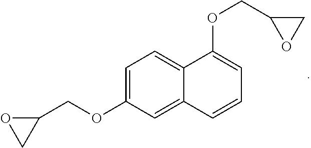 [SMILES: c1cc(OCC2CO2)c2ccc(OCC3CO3)cc2c1]

8000-65T had a chemical structure of

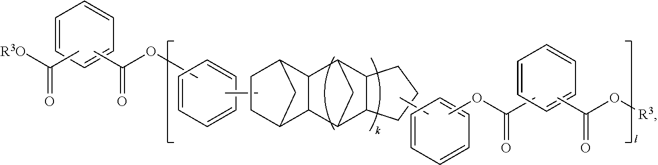

wherein R³ was phenyl or naphthyl, k was 0 to 1, and 1 was 0 to 2.

### Example 2

326 g of the product in Synthesis Example 2, 27.2 g of the anthracene type diepoxy compound 4032D, 196 g of the curing agent 8000-65T, and 3 g of the initiator DMAP were dissolved in 1000 mL of THF. The THF solution was refluxed and reacted for 2 hours to obtain a copolymer. The product in Synthesis Example 2 (e.g. (a) first epoxy compound) and 4032D (e.g. (b) the second epoxy compound) had a molar ratio of 90:10. (a) The first epoxy compound and (b) the second epoxy compound had an equivalent ratio of 100:11.11. The total equivalent of (a) the first epoxy compound and (b) the second epoxy compound and the equivalent of (c) the curing agent had a ratio of about 100:90. The copolymer was coated to form a film, and then baking dried to form a coating layer with a thickness of about 100 μm. The coating layer had a heat transfer coefficient of 0.385 W/mK, a coefficient of thermal expansion of 38.1 ppm/° C., and a glass transition temperature (Tg) of 186° C.

### Example 3

380 g of the product in Synthesis Example 3, 272 g of the anthracene type diepoxy compound 4032D, 356 g of the curing agent 8000-65T, and 3 g of the initiator DMAP were dissolved in 1000 mL of THF. The THF solution was refluxed and reacted for 2 hours to obtain a copolymer. The product in Synthesis Example 3 (e.g. (a) first epoxy compound) and 4032D (e.g. (b) the second epoxy compound) had a molar ratio of 50:50. (a) The first epoxy compound and (b) the second epoxy compound had an equivalent ratio of 100:100. The total equivalent of (a) the first epoxy compound and (b) the second epoxy compound and the equivalent of (c) the curing agent had a ratio of about 100:90. The copolymer was coated to form a film, and then baking dried to form a coating layer with a thickness of about 100 μm. The coating layer had a heat transfer coefficient of 0.315 W/mK, a coefficient of thermal expansion of 36.4 ppm/° C., and a glass transition temperature (Tg) of 190° C.

### Example 4

187 g of the product in Synthesis Example 1, 204 g of the product in Synthesis Example 2, 6.8 g of the anthracene type diepoxy compound 4032D, 227 g of the curing agent 8000-65T, and 3 g of the initiator DMAP were dissolved in 1000 mL of THF. The THF solution was refluxed and reacted for 2 hours to obtain a copolymer. The product in Synthesis Example 1 (e.g. (a) first epoxy compound), the product in Synthesis Example 2 (e.g. (a) first epoxy compound), and 4032D (e.g. (b) the second epoxy compound) had a molar ratio of 49:49:2. (a) The first epoxy compound and (b) the second epoxy compound had an equivalent ratio of 100:2.04. The total equivalent of (a) the first epoxy compound and (b) the second epoxy compound and the equivalent of (c) the curing agent had a ratio of about 100:90. The copolymer was coated to form a film, and then baking dried to form a coating layer with a thickness of about 100 μm. The coating layer had a heat transfer coefficient of 0.403 W/mK, a coefficient of thermal expansion of 44.7 ppm/° C., and a glass transition temperature (Tg) of 176° C.

### Example 5

163 g of the product in Synthesis Example 2, 190 g of the product in Synthesis Example 3, 27.2 g of the anthracene type diepoxy compound 4032D, 196 g of the curing agent 8000-65T, and 3 g of the initiator DMAP were dissolved in 1000 mL of THF. The THF solution was refluxed and reacted for 2 hours to obtain a copolymer. The product in Synthesis Example 2 (e.g. (a) first epoxy compound), the product in Synthesis Example 3 (e.g. (a) first epoxy compound), and 4032D (e.g. (b) the second epoxy compound) had a molar ratio of 45:45:10. (a) The first epoxy compound and (b) the second epoxy compound had an equivalent ratio of 100:11.11. The total equivalent of (a) the first epoxy compound and (b) the second epoxy compound and the equivalent of (c) the curing agent had a ratio of about 100:90. The copolymer was coated to form a film, and then baking dried to form a coating layer with a thickness of about 100 μm. The coating layer had a heat transfer coefficient of 0.355 W/mK, a coefficient of thermal expansion of 40.1 ppm/° C., and a glass transition temperature (Tg) of 183° C.

### Example 6

149 g of the product in Synthesis Example 1, 190 g of the product in Synthesis Example 3, 272 g of the anthracene type diepoxy compound 4032D, 356 g of the curing agent 8000-65T, and 3 g of the initiator DMAP were dissolved in 1000 mL of THF. The THF solution was refluxed and reacted for 2 hours to obtain a copolymer. The product in Synthesis Example 1 (e.g. (a) first epoxy compound), the product in Synthesis Example 3 (e.g. (a) first epoxy compound), and 4032D (e.g. (b) the second epoxy compound) had a molar ratio of 25:25:50. (a) The first epoxy compound and (b) the second epoxy compound had an equivalent ratio of 100:100. The total equivalent of (a) the first epoxy compound and (b) the second epoxy compound and the equivalent of (c) the curing agent had a ratio of about 100:90. The copolymer was coated to form a film, and then baking dried to form a coating layer with a thickness of about 100 μm. The coating layer had a heat transfer coefficient of 0.301 W/mK, a coefficient of thermal expansion of 38.2 ppm/° C., and a glass transition temperature (Tg) of 187° C. .

### Synthesis Example 4

4,4′-Biphenol (186 g, 1 mol), methacrylic anhydride (370 g, 2.4 mol), and sodium hydrogen carbonate (17 g, 0.2 mol) were mixed and heated to 80° C. under nitrogen and reacted for 2 hours. 2M of aqueous solution of sodium hydroxide (1L) was added to the reaction result and stirred overnight, filtered, washed with water, and baking dried to obtain a product (306 g). The product had a chemical structure of

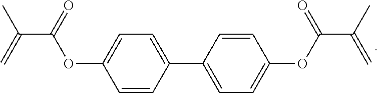 [SMILES: C=C(C)C(=O)Oc1ccc(-c2ccc(OC(=O)C(=C)C)cc2)cc1]

### Comparative Example 1

402 g of the product in Synthesis Example 4, 8 g of bismaleimide (BMI-TMH, commercially available from Daiwa Kasei Kogyo Co., Ltd.), and 4 g of a radical initiator 101 (2,5-bis(tert-butyl peroxy)-2,5-dimethylhexane, commercially available from Aldrich) were dissolved in 1000 mL of cyclohexanone, and then refluxed to react for 2 hours to obtain a copolymer. The product in Synthesis Example 4 and BMI-TMH had a molar ratio of 98:2. The copolymer was coated to form a film, and then baking dried to form a coating layer with a thickness of 100 The coating layer had a heat transfer coefficient of 0.416 W/mK, a coefficient of thermal expansion of 78.4 ppm/° C., and a glass transition temperature (Tg) of 171° C. BMI-TMH had a chemical structure of

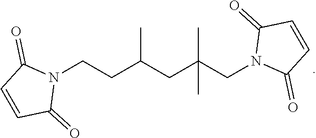 [SMILES: CC(CCN1C(=O)C=CC1=O)CC(C)(C)CN1C(=O)C=CC1=O]

### Example 7

303 g of the copolymer in Example 1, 30 g of the copolymer in Comparative Example 1, and 7 g of an initiator 2E4MZ (2-Ethyl-4-Methyl Imidazole commercially available from Aldrich) were dissolved in 1000 mL of THF. The THF solution was refluxed and reacted for 2 hours to form a resin. The copolymer in Example 1 and the copolymer in Comparative Example 1 had a weight ratio of 91:9. The resin was coated to form a film, and then baking dried to form a coating layer with a thickness of about 100 The coating layer had a heat transfer coefficient of 0.41 W/mK, a coefficient of thermal expansion of 47.6 ppm/° C., a dielectric constant at high frequency (DK@10GHz) of 2.86, and a dielectric loss at high frequency (DF@10 GHz) of 0.0067.

### Example 8

240 g of the copolymer in Example 1, 60 g of the copolymer in Comparative Example 1, and 6 g of the initiator 2E4MZ were dissolved in 1000 mL of THF. The THF solution was refluxed and reacted for 2 hours to form a resin. The copolymer in Example 1 and the copolymer in Comparative Example 1 had a weight ratio of 80:20. The resin was coated to form a film, and then baking dried to form a coating layer with a thickness of about 100 μm. The coating layer had a heat transfer coefficient of 0.385 W/mK, a coefficient of thermal expansion of 51.3 ppm/° C., a dielectric constant at high frequency (DK@10 GHz) of 2.8, and a dielectric loss at high frequency (DF@10GHz) of 0.0059.

### Example 9

204 g of the copolymer in Example 1, 204 g of the copolymer in Comparative Example 1, and 8 g of the initiator 2E4MZ were dissolved in 1000 mL of THF. The THF solution was refluxed and reacted for 2 hours to form a resin. The copolymer in Example 1 and the copolymer in Comparative Example 1 had a weight ratio of 50:50. The resin was coated to form a film, and then baking dried to form a coating layer with a thickness of about 100 μm. The coating layer had a heat transfer coefficient of 0.388 W/mK, a coefficient of thermal expansion of 55.6 ppm/° C., a dielectric constant at high frequency (DK@10 GHz) of 2.72, and a dielectric loss at high frequency (DF@10 GHz) of 0.0052.

### Example 10

Example 10 was similar to Example 9, and the difference in Example 10 was 175 g of silica being further added into the resin to form a composite material. The silica and the resin had a weight ratio of about 30:70. The composite material was coated to form a film, and then baking dried to form a coating layer with a thickness of about 100 μm. The coating layer had a heat transfer coefficient of 0.398 W/mK, a coefficient of thermal expansion of 43.2 ppm/° C., a dielectric constant at high frequency (DK@10 GHz) of 2.74, and a dielectric loss at high frequency (DF@10 GHz) of 0.0049.

### Example 11

Example 11 was similar to Example 9, and the difference in Example 11 was 408 g of silica being further added into the resin to form a composite material. The silica and the resin had a weight ratio of about 50:50. The composite material was coated to form a film, and then baking dried to form a coating layer with a thickness of about 100 μm. The coating layer had a heat transfer coefficient of 0.425 W/mK, a coefficient of thermal expansion of 28.2 ppm/° C., a dielectric constant at high frequency (DK@10 GHz) of 2.71, and a dielectric loss at high frequency (DF@10 GHz) of 0.0046.

### Example 12

Example 12 was similar to Example 9, and the difference in Example 12 was 952 g of silica being further added into the resin to form a composite material. The silica and the resin had a weight ratio of about 70:30. The composite material was coated to form a film, and then baking dried to form a coating layer with a thickness of about 100 μm. The coating layer had a heat transfer coefficient of 0.447 W/mK, a coefficient of thermal expansion of 18.8 ppm/° C., a dielectric constant at high frequency (DK@10 GHz) of 2.58, and a dielectric loss at high frequency (DF@10 GHz) of 0.004.

### Example 13

326 g of the product in Synthesis Example 2, 170 g of the anthracene type tetraepoxy compound 4710 commercially available from DIC, 94 g of the triazine curing agent commercially available from Acros, and 3 g of the initiator 2E4MZ were dissolved in 1000 mL of THF. The THF solution was refluxed and reacted for 2 hours to obtain a copolymer. The product in Synthesis Example 2 (e.g. (a) first epoxy compound) and 4710 (e.g. (b) the second epoxy compound) had a molar ratio of 50:50. (a) The first epoxy compound and (b) the second epoxy compound had an equivalent ratio of 100:50. The total equivalent of (a) the first epoxy compound and (b) the second epoxy compound and the equivalent of (c) the curing agent had a ratio of about 100:100. The copolymer was coated to form a film, and then baking dried to form a coating layer with a thickness of 100 μm. The coating layer had a heat transfer coefficient of 0.284 W/mK, a coefficient of thermal expansion of 42.6 ppm/° C., and a glass transition temperature (Tg) of 164° C. 4710 had a chemical structure of

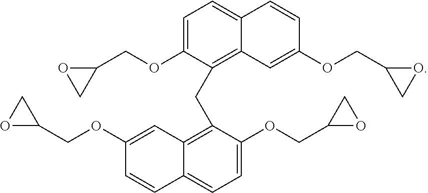 [SMILES: c1cc2ccc(OCC3CO3)c(Cc3c(OCC4CO4)ccc4ccc(OCC5CO5)cc34)c2cc1OCC1CO1]

The triazine curing agent had a chemical structure of

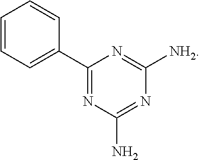 [SMILES: Nc1nc(N)nc(-c2ccccc2)n1]

### Example 14

489 g of the product in Synthesis Example 2, 85 g of the anthracene type tetraepoxy compound 4710, 94 g of the triazine curing agent, and 3.5 g of the initiator 2E4MZ were dissolved in 1000 mL of THF. The THF solution was refluxed and reacted for 2 hours to obtain a copolymer. The product in Synthesis Example 2 (e.g. (a) first epoxy compound) and 4710 (e.g. (b) the second epoxy compound) had a molar ratio of 75:25. (a) The first epoxy compound and (b) the second epoxy compound had an equivalent ratio of 100:16.67. The total equivalent of (a) the first epoxy compound and (b) the second epoxy compound and the equivalent of (c) the curing agent had a ratio of about 100:100. The copolymer was coated to form a film, and then baking dried to form a coating layer with a thickness of 100 μm. The coating layer had a heat transfer coefficient of 0.302 W/mK, a coefficient of thermal expansion of 55.7 ppm/° C., and a glass transition temperature (Tg) of 157° C.

### Example 15

326 g of the product in Synthesis Example 2, 272 g of the anthracene type multi-epoxy compound 9900 commercially available from DIC, 94 g of the triazine curing agent, and 3.5 g of the initiator 2E4MZ were dissolved in 1000 mL of THF. The THF solution was refluxed and reacted for 2 hours to obtain a copolymer. The product in Synthesis Example 2 (e.g. (a) first epoxy compound) and 9900 (e.g. (b) the second epoxy compound) had a molar ratio of 50:50. (a) The first epoxy compound and (b) the second epoxy compound had an equivalent ratio of 100:100. The total equivalent of (a) the first epoxy compound and (b) the second epoxy compound and the equivalent of (c) the curing agent had a ratio of about 100:100. The copolymer was coated to form a film, and then baking dried to form a coating layer with a thickness of 100 μm. The coating layer had a heat transfer coefficient of 0.298 W/mK, a coefficient of thermal expansion of 51.4 ppm/° C., and a glass transition temperature (Tg) of 159° C. The anthracene type multi-epoxy compound 9900 had a chemical structure of

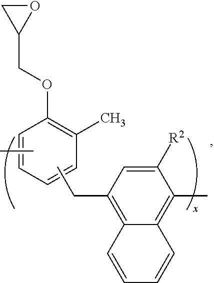

wherein R² is CₙH₂ₙ₊₁, n was 1 to 5, and x was 1 to 3.

### Example 16

326 g of the product in Synthesis Example 2, 190 g of the anthracene type diepoxy compound YX4000 commercially available from Mitsubishi Chemical, 94 g of the triazine curing agent, and 3.5 g of the initiator 2E4MZ were dissolved in 1000 mL of THF. The THF solution was refluxed and reacted for 2 hours to obtain a copolymer. The product in Synthesis Example 2 (e.g. (a) first epoxy compound) and YX4000 (e.g. (b) the second epoxy compound) had a molar ratio of 50:50. (a) The first epoxy compound and (b) the second epoxy compound had an equivalent ratio of 100:100. The total equivalent of (a) the first epoxy compound and (b) the second epoxy compound and the equivalent of (c) the curing agent had a ratio of about 100:90. The copolymer was coated to form a film, and then baking dried to form a coating layer with a thickness of 100 μm. The coating layer had a heat transfer coefficient of 0.275 W/mK, a coefficient of thermal expansion of 62.8 ppm/° C., and a glass transition temperature (Tg) of 153° C. YX4000 had a chemical structure of

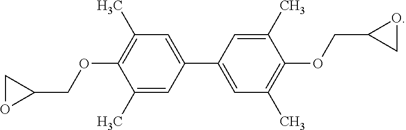 [SMILES: Cc1cc(-c2cc(C)c(OCC3CO3)c(C)c2)cc(C)c1OCC1CO1]

### Example 17

373 g of the product in Synthesis Example 2, 188 g of the diepoxy compound 1010A commercially available from Truetime Industrial, 266 g of the anhydride curing agent commercially available from Acros, and 3 g of the initiator 2EZ (2-Ethyl-imidazole commercially available from Aldrich) were dissolved in 1000 mL of THF. The THF solution was refluxed and reacted for 2 hours to obtain a copolymer. The product in Synthesis Example 2 (e.g. (a) first epoxy compound) and 1010A (e.g. (b) the second epoxy compound) had a molar ratio of 50:50. (a) The first epoxy compound and (b) the second epoxy compound had an equivalent ratio of 100:100. The total equivalent of (a) the first epoxy compound and (b) the second epoxy compound and the equivalent of (c) the curing agent had a ratio of about 100:90. The copolymer was coated to form a film, and then baking dried to form a coating layer with a thickness of 100 μm. The coating layer had a heat transfer coefficient of 0.268 W/mK, a coefficient of thermal expansion of 82.5 ppm/° C., and a glass transition temperature (Tg) of 147° C. 1010A had a chemical structure of

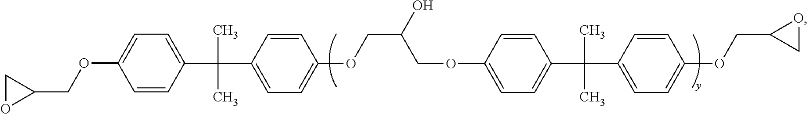

wherein y was 0 to 2. The anhydride curing agent had a chemical structure of

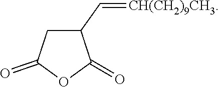

### Example 18

373 g of the product in Synthesis Example 2, 188 g of the diepoxy compound 1010A commercially available from Truetime Industrial, 83 g of a diacid curing agent, and 3 g of the initiator 2MZ (2-Methyl-imidazole commercially available from Aldrich) were dissolved in 1000 mL of THF. The THF solution was refluxed and reacted for 2 hours to obtain a copolymer. The product in Synthesis Example 2 (e.g. (a) first epoxy compound) and 1010A (e.g. (b) the second epoxy compound) had a molar ratio of 50:50. (a) The first epoxy compound and (b) the second epoxy compound had an equivalent ratio of 100:100. The total equivalent of (a) the first epoxy compound and (b) the second epoxy compound and the equivalent of (c) the curing agent had a ratio of about 100:90. The copolymer was coated to form a film, and then baking dried to form a coating layer with a thickness of 100 μm. The coating layer had a heat transfer coefficient of 0.263 W/mK, a coefficient of thermal expansion of 78.4 ppm/° C., and a glass transition temperature (Tg) of 145° C. The diacid curing agent had a chemical structure of

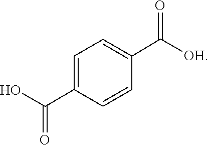 [SMILES: O=C(O)c1ccc(C(=O)O)cc1]

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A copolymer, formed by reacting a composition I,
wherein the composition I includes:
(a) a first epoxy compound having a chemical structure of 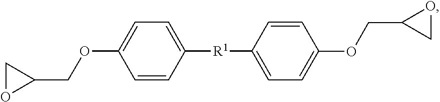
wherein R¹ is single bond, 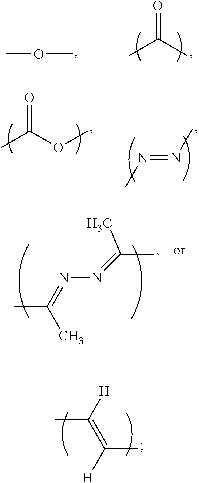
(b) a second epoxy compound that is different from (a) the first epoxy compound; and
(c) a curing agent.

2. The copolymer as claimed in claim 1, wherein (a) the first epoxy compound comprises 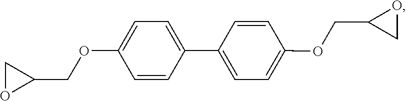 [SMILES: c1cc(-c2ccc(OCC3CO3)cc2)ccc1OCC1CO1]
or a combination thereof.

3. The copolymer as claimed in claim 1, wherein (b) the second epoxy compound has a chemical structure of 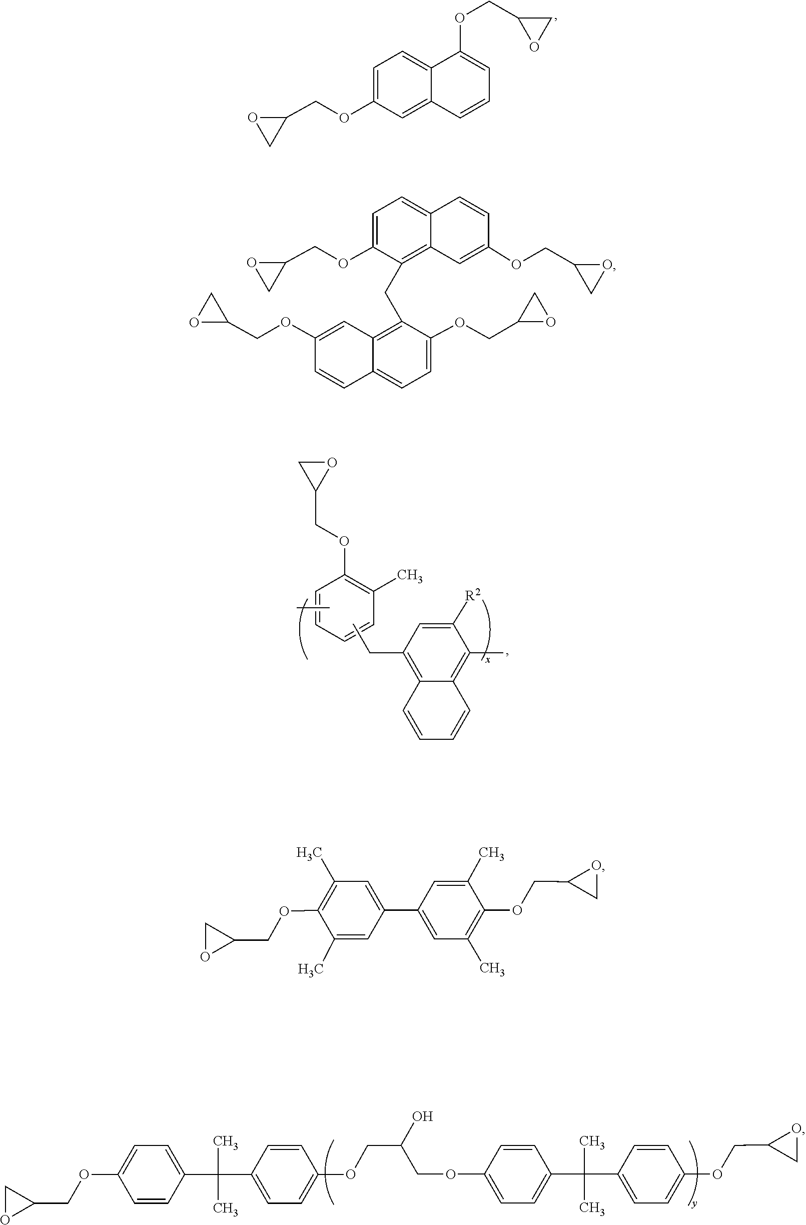
or a combination thereof, wherein R² is CₙH₂ₙ₊₁, n is 1 to 5, x is 1 to 3, and y is 0 to 2.

4. The copolymer as claimed in claim 1, wherein (a) the first epoxy compound and (b) the second epoxy compound have an equivalent ratio of 100:1 to 100:120.

5. The copolymer as claimed in claim 1, wherein (c) the curing agent has a chemical structure of 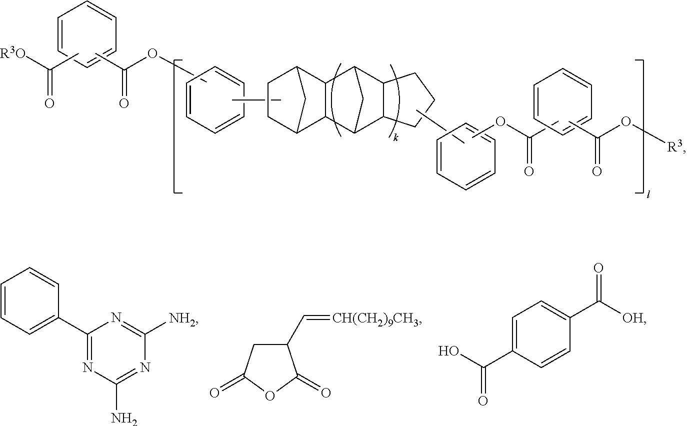
or a combination thereof, wherein each R³ is independently phenyl or naphthyl, k is 0 to 3, and l is 0 to 5.

6. The copolymer as claimed in claim 1, wherein the total equivalent of (a) the first epoxy compound and (b) the second epoxy compound and the equivalent of (c) the curing agent have a ratio of 100:70 to 100:120.

7. A composite material, comprising:
the copolymer as claimed in claims 1; and
inorganic powder,
wherein the copolymer and the inorganic powder have a weight ratio of 100:30 to 100:300.

8. A resin, formed by reacting a composition O,
wherein the composition O comprises a first copolymer and a second copolymer,
wherein the first copolymer is formed by reacting a composition I, and the composition I comprises:
(a) a first epoxy compound having a chemical structure of 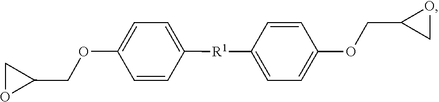
wherein R¹ single bond, 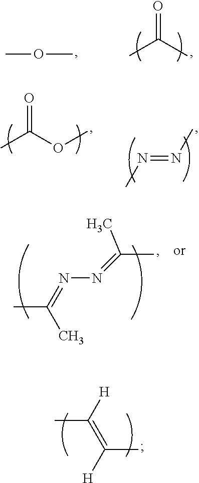
(b) a second epoxy compound that is different from (a) the first epoxy compound; and
(c) a curing agent,
wherein the second copolymer is formed by reacting a composition II, and the composition II comprises:
(d) an aromatic monomer, an oligomer thereof, or a polymer thereof; and
(e) an aliphatic monomer, an oligomer thereof, or a polymer thereof,
wherein the aromatic monomer has a chemical structure of 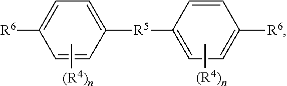
wherein R⁴ is CH₃ and n is 0 to 4;
R⁵ is single bond, 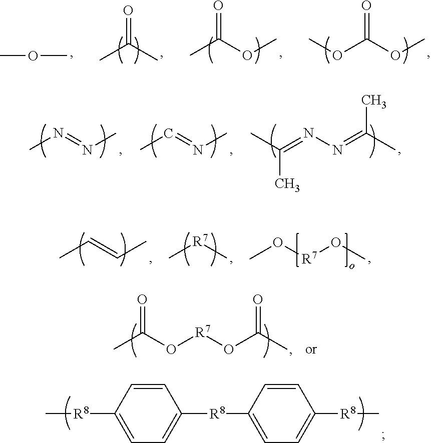
R⁷ is C₂₋₁₀ alkylene group;
each of R⁸ is independently a single bond, 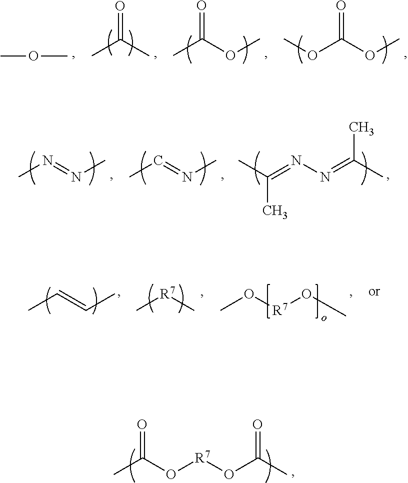
and o is 1 to 70;
each of R⁶ is independently 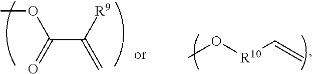
wherein R⁹ is H or CH₃, and R¹⁰ is C₁₋₁₀ alkylene group.

9. The resin as claimed in claim 8, wherein the aromatic monomer has a chemical structure of

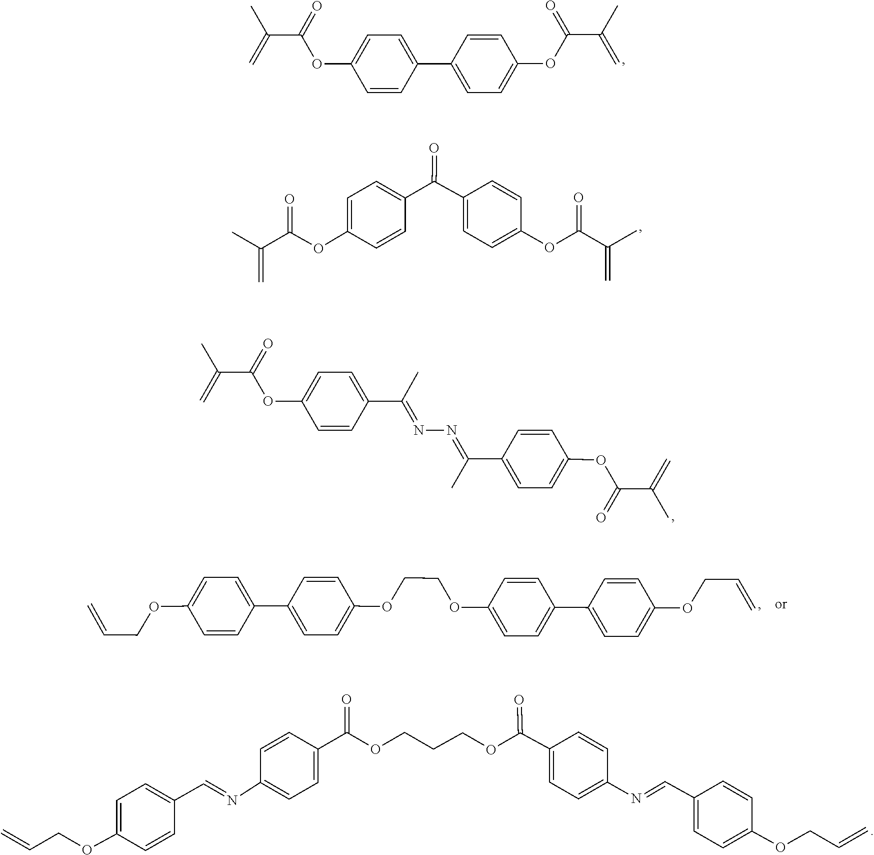

10. The resin as claimed in claim 8, wherein the aliphatic monomer is 1,3-butadiene, isoprene, 1,3-pentadiene, 2,3-dimethyl-1,3-butadiene, 2-methyl-1,3-pentadiene, 2,3-dimethyl-1,3-pentadiene, 4,5-diethyl-1,3-octadiene, 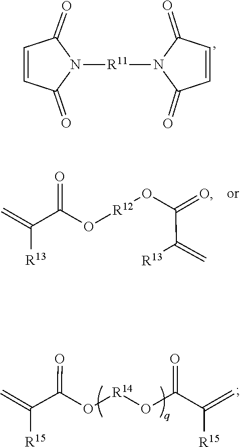
wherein R¹¹ is C₁₋₁₂ alkylene group or cycoalkylene group;
R¹² is 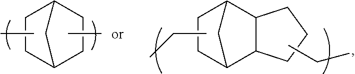
each of R¹³ is independently H or CH₃;
R¹⁴ is C₂₋₅ alkylene group;
each of R¹⁵ is independently H or CH₃; and
q is 1 to 70.

11. The resin as claimed in claim 8, wherein the aliphatic monomer is 1,3-butadiene,

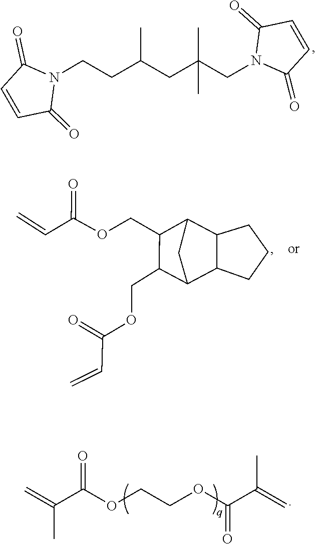

12. The resin as claimed in claim 8, wherein (d) the aromatic monomer, an oligomer thereof, or a polymer thereof; and (e) the aliphatic monomer, an oligomer thereof, or a polymer thereof have a molar ratio (d/e) of 1:2 to 99:1.

13. The resin as claimed in claim 8, wherein the first copolymer and the second copolymer have a weight ratio of 100:5 to 110:120.

14. A composite material, comprising:
the resin as claimed in claims 8; and
inorganic powder,
wherein the resin and the inorganic powder have a weight ratio of 100:30 to 100:300.
